(19) United States
(12) Patent Application Publication
(10) Pub. No.: US 2003/0210711 A1
(43) Pub. Date: Nov. 13, 2003

(54) Data transfer method and apparatus

(76) Inventors: Albert William Faust, Markham (CA); Tracy Arthur Bond, Vancouver (CA); David Michael Dickson, Surrey (CA)

Correspondence Address: GOWLING LAFLEUR HENDERSON, Suite 2600, 160 Elgin Street, Ottawa, ON, K1P 1C3, CA

(21) Appl. No.: 10/140,100

(22) Filed: May 8, 2002

(51) Int. Cl. H04J 3/24

(52) U.S. Cl. 370/474; 370/394

(57) ABSTRACT

A method and apparatus are disclosed that allow a user to transfer relatively large files, such as full motion video, over a dedicated link with improved efficiency. Relatively cost effective high-speed TCP/IP links are available. However latency issues with TCP/IP prevents their use for transferring large files, especially full motion video for viewing in real time. The present method and apparatus establishes a multi-channel pipeline within the high-speed link from a source node to a target node. A desired file resident on a server of source node is first parsed into chunks of predetermined size appended with a sequence number and placed into circular buffer. The circular buffer is emptied into a next available channel in the multi-channel pipeline established in the high-speed link. The TCP/IP socket channels transfer chunks from the source node to the target node and acknowledge each chunk and then allow circular buffer to transfer the next available chunk. The target node stores the incoming chunks in circular buffer then transfers them in the file assembler into memory in dependence upon the sequence number. Once the file is reassembled it is transferred to server and made available to end user. Advantageously, a more cost effective link may be used for transfer of relatively large files. This technique may also be applied to access networks.

### FIELD OF THE INVENTION

The present invention relates to data transfer method and apparatus, and is particularly concerned with efficient data channel use.

### BACKGROUND OF THE INVENTION

The successful conversion from analogue to digital signals in most sectors of the electronics industry has lead to the need for increased bandwidth in networks and increased storage capacity. A particularly bandwidth hungry sector is the video industry. For bandwidth limited networks, defacto applications such as Quicktime a trademark of Apple Computers allow the streaming of video at much reduced bit rates. The television industry, however requires full motion broadcast quality video. Compression algorithms have been developed and incorporated in standards, for example MPEG2, that allow full motion video to be compressed for transmission and storage and restored for playback. However, even with the use of compression, video transmission in real time requires a bandwidth of several megabits per second (Mb/s). Consequently, television broadcasters have to lease high-bandwidth digital lines between programs sources and broadcast stations. These leased lines are sufficient expensive to have an impact on how programming is distributed and particularly how segments, such as news items are shared within a network. While several alternative networks are becoming available that could provide sufficient bandwidth, for example asynchronous transfer mode (ATM) or synchronous optical network (SONET), costs for such services remain high. This is simply a function of the large amount of data that must be transferred.

### SUMMARY OF THE INVENTION

An object of the present invention is to provide an improved data transfer method and apparatus.

In accordance with an aspect of the present invention there is provided a method of data transfer comprising the steps of activating a link between a first location and a second location, subdividing the link into a plurality of data transfer channels and a data transfer control channel, at the first location, parsing a file to be transferred into a plurality of chunks, each chunk having a predetermined size, sequencing and sending each chunk on a next available one of the plurality of data transfer channels, and at the second location, reassembling the file by receiving and reordering chunks in dependence upon their sequence.

In accordance with another aspect of the present invention there is provided apparatus for data transfer from a first location to a second location, comprising a link between a first location and a second location, a module for subdividing the link into a plurality of data transfer channels and a data transfer control channel, a file parser at the first location, for parsing a file to be transferred into a plurality of chunks, each chunk having a predetermined size, a chunk sequencer for sequencing the chunks prior to transmission, and a transmitter for sending each chunk on a next available one of the plurality of data transfer channels for reassembling the file at the second location, by receiving and reordering chunks in dependence upon their sequence.

In accordance with a further aspect of the present invention there is provided an apparatus for receiving data from a first location at a second location, comprising: a link between a first location and a second location, a module for subdividing the link into a plurality of data transfer channels and a data transfer control channel, a file assembler at the second location, for reassembling the file at the second location, by receiving and reordering chunks in dependence upon their sequence.

An advantage of the present invention is increased efficiency of channel use for a relatively cost effective channel.

A further advantage of the present invention is providing a higher throughput of data for a given link data rate.

### BRIEF DESCRIPTION OF THE DRAWINGS

The present invention will be further understood from the following detailed description with reference to the drawings in which:

FIG. 1 illustrates in a functional block diagram a network including apparatus for data transfer in accordance with an embodiment of the present invention;

FIG. 2 illustrates in a functional block diagram further detail of a portion of FIG. 1; and

FIG. 3 illustrates in a functional block diagram further detail of the file transfer service of nodes and the dispatcher of FIGS. 1 and 2; and

FIG. 4 illustrates in a flow chart steps for fast copy channel set up for the method of file transfer in accordance with an embodiment of the present invention.

FIG. 5 method of file transfer in accordance with an embodiment of the present invention.

### DETAILED DESCRIPTION OF THE PREFERRED EMBODIMENT

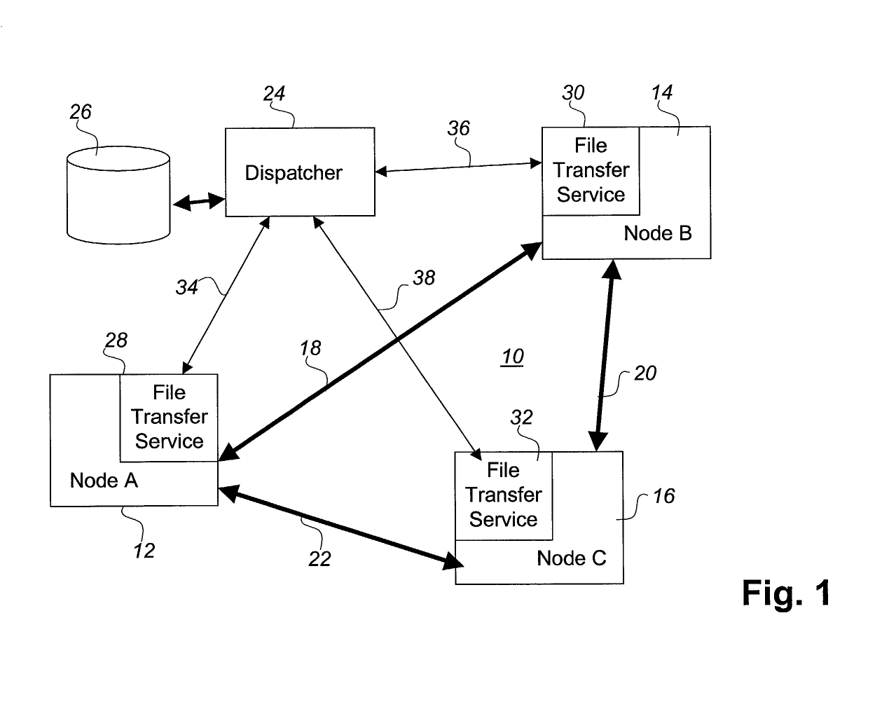

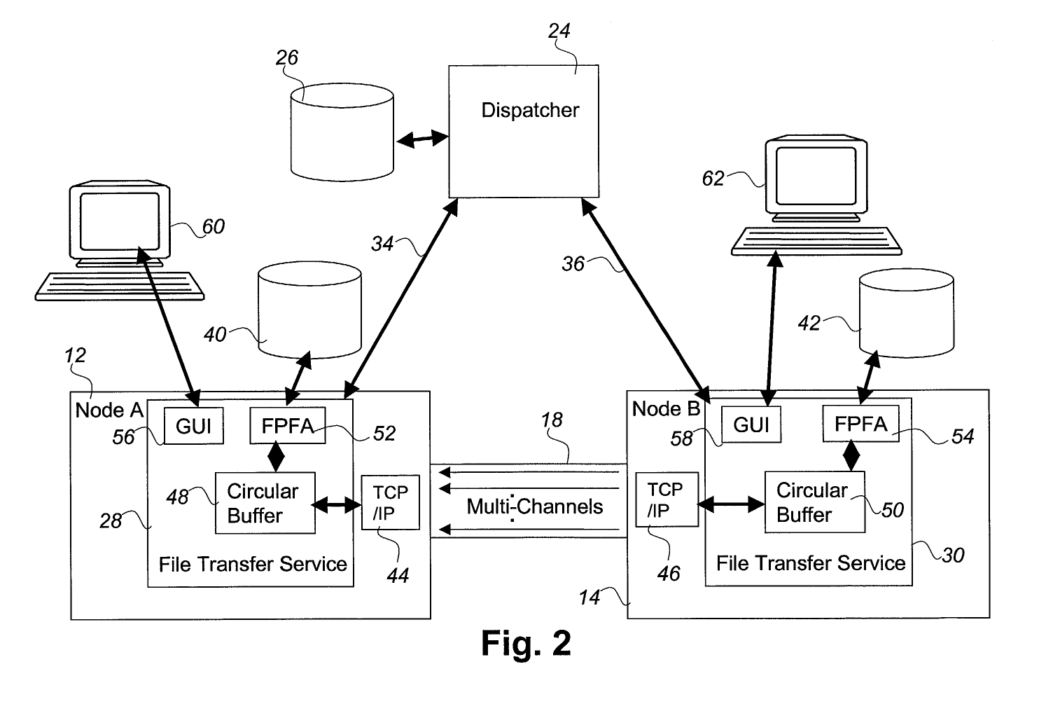

Referring to FIG. 1 there is illustrated, in a functional block diagram, a network including apparatus for data transfer in accordance with an embodiment of the present invention. The network 10 includes nodes 12, 14, and 16 interconnected in a full mesh network by high-speed links 18, 20, and 22. The network also includes a dispatcher 24 coupled to the network database 26. Nodes 12, 14, and 16 include a file transfer service 28, 30 and 32 respectively. File transfer service 28, 30, and 32 are coupled to the dispatcher 24 via links 34, 36, and 38 respectively.

In operation, use of the high-speed links 18, 20 and 22 is coordinated by the dispatcher 24 as will be explained in further detail in regard to the following figures.

Referring to FIG. 2 there is illustrated in a functional block diagram further detail of a portion of FIG. 1. FIG. 2 illustrates an example of file transfer between two nodes of FIG. 1. Each node 12 and 14 includes in addition to the file transfer service 28 and 30 respectively databases 40 and 42 respectively and TCP/IP interfaces 44 and 46 respectively. Each file transfer service includes a circular buffer 48 and 50 respectively, a file parser/assembler 52 and 54, respectively. File transfer services 28 and 30 also include graphic user interfaces 56 and 58 for interfacing with for example the end user 60 and 62.

In operation, a user 60 requests a file transfer from a remote node 14 via GUI 56, links 34 and 36 from node 12 and node 14 are activated to dispatcher 24 who provides the source node for example node 14 with the identity of the target node 12 for establishing the high-speed transfer via high-speed link 18. Nodes 12 and 14 establish a multi-channel pipeline within high-speed link 18 from the source node 14 to the target node 12. A desired file resident on server 42 of node 14 is first parsed into chunks of predetermined size appended with a sequence number and placed into circular buffer 50. Circular buffer 50 is emptied into a next available channel in the multi-channel established in high-speed link 18. The TCP/IP channels transfer chunks from node 14 to node 12 acknowledge each chunk and then allow circular buffer to transfer the next available chunk. The target node 12 stores the incoming chunks in circular buffer 48 then transfers them in the file parser/assembler 52 into memory and depends upon the sequence number. Once the file is reassembled it is transferred to server 40 and made available to end user 60.

The method of FIGS. 1 and 2 include the following functionality:

1) File Creation

a) store locally, e.g. Servers 40 and 42

b) store and transmit via the fast copy channel (FCC) as file is created. For example converting analogue or digital broadcast video to an MPEG2 file.

2) File selection/transmission using web/database user interface and FCC;

3) Selection ad playback of broadcast video using web/database interface

4) Retrieval from archive of video onto operational servers eg. 40 and 42, using web/database interface.

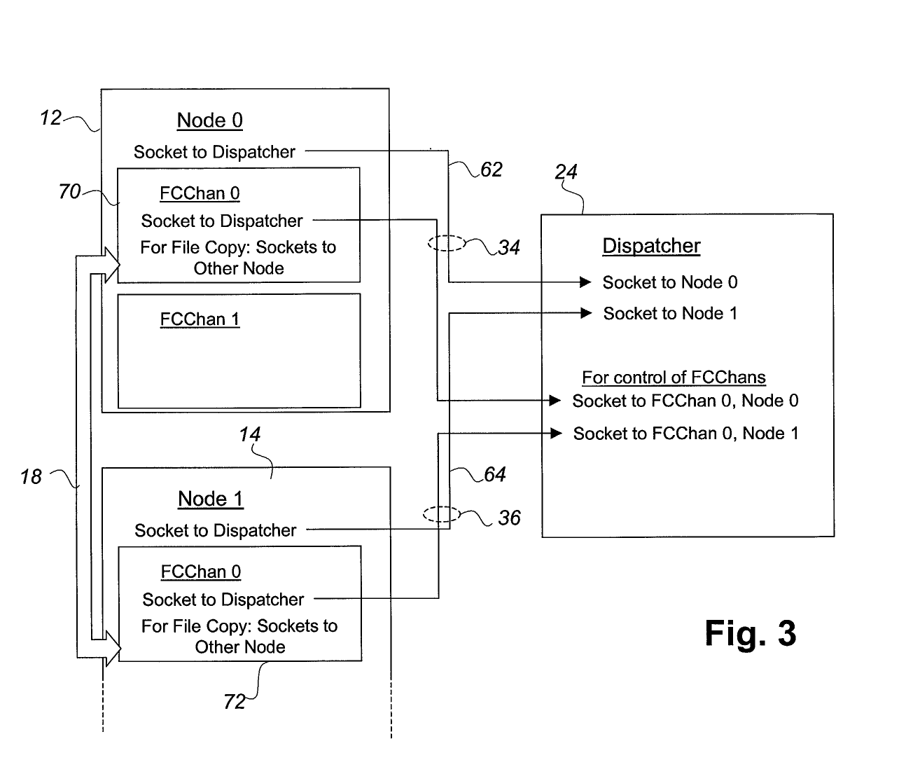

Referring to FIG. 3 there is illustrated in a functional block diagram further detail of the file transfer service of nodes and the dispatcher of FIGS. 1 and 2. In establishing the links 34 and 36 node 12 establishes a socket connection to the dispatcher initiated from the node. Similarly node 14 establishes a socket connection 64 to dispatcher 24. Each node sets up a fast copy channel set of sockets 70 and 72 respectively including one socket to the dispatcher for controlling the fast copy channel and a plurality of sockets to the other node.

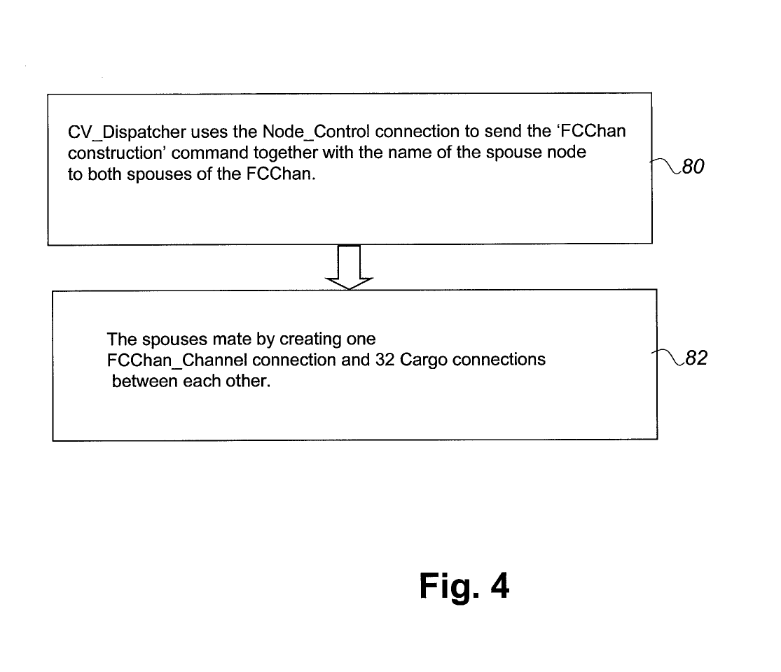

Referring to FIG. 4 there is illustrated in a flow chart steps for fast copy channel set up for the method of file transfer in accordance with an embodiment of the present invention.

Construction of the fast copy channel (FCChan) includes the steps of:

a) CV_Dispatcher using the Node_Control connection to send the ‘FCChan construction’ command together with the name of the spouse node to both spouses of the FCChan, as represented by block 80.

b) The spouses mate by creating one FCChan_Channel connection and 32 Cargo connections between each other, as represented by block 82.

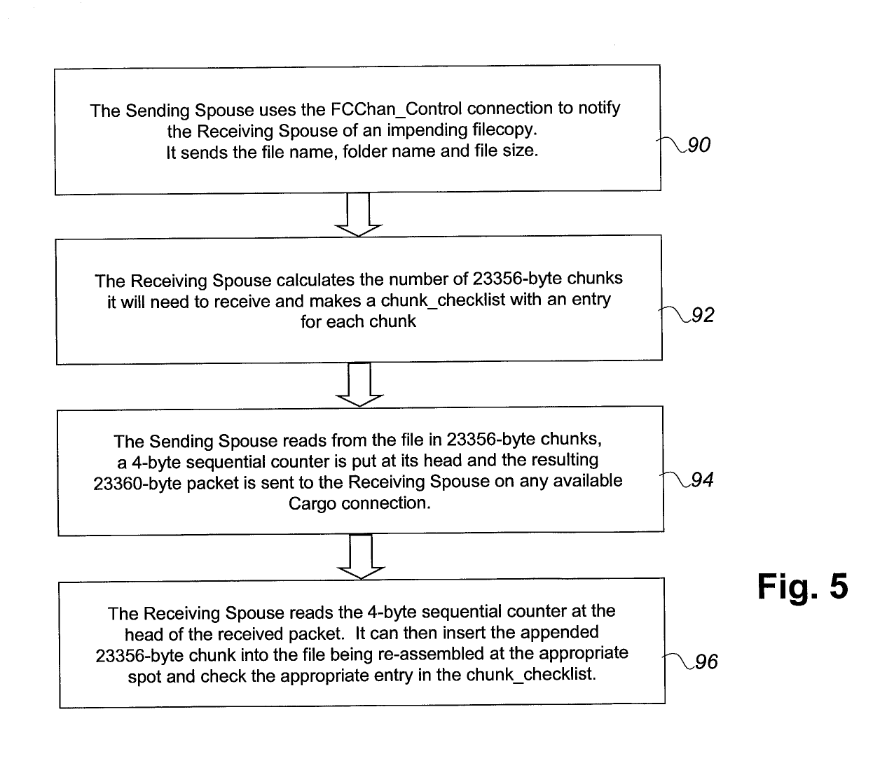

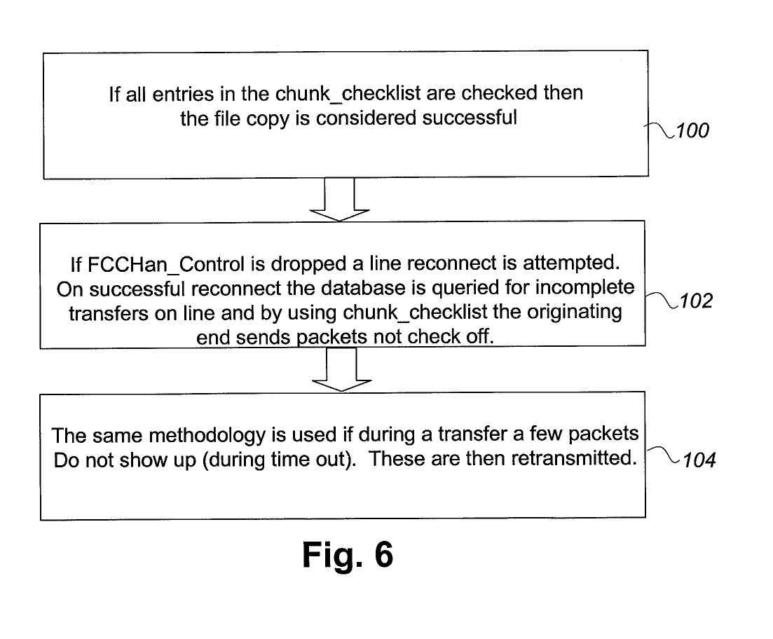

Referring to FIG. 5 there is illustrated in a flow chart steps for file copying using the fast copy channel set up in FIG. 4 for the method of file transfer in accordance with an embodiment of the present invention.

The File Copying steps are:

a) The Sending Spouse uses the FCChan_Control connection to notify the Receiving Spouse of an impending filecopy. It sends the file name, folder name and file size, as represented by block 90.

b) The Receiving Spouse calculates the number of 23356-byte chunks it will need to receive and makes a chunk_checklist with an entry for each chunk, as represented by block 92.

c) The Sending Spouse reads from the file in 23356-byte chunks, a 4-byte sequential counter is put at its head and the resulting 23360-byte packet is sent to the Receiving Spouse on any available Cargo connection, as represented by block 94.

d) The Receiving Spouse reads the 4-byte sequential counter at the head of the received packet. It can then insert the appended 23356-byte chunk into the file being re-assembled at the appropriate spot and check the appropriate entry in the chunk_checklist, as represented by block 96.

Referring to FIG. 6 there is illustrated in a flow chart steps for error handling during the file copying of FIG. 5. Error handling includes the following steps:

a) If all entries in the chunk_checklist are checked then the FileCopy is considered successful.

Network Drops

If FCChan_Control is dropped a line reconnect is attempted. On successful reconnect the database is queried for incomplete transfers on line and by using chunk_checklist the originating end sends packets not check off, as represented by block 102.

File Corruption

The same methodology is used if during a transfer a few packets do not show up (during time out). These are then retransmitted, as represented by block 104.

Both of these scenarios are possible because a file is parsed into 23356-byte chucks the same way every time. Therefore, for a given file ABC, chunk 100 contains the same data if file ABC needs to be read a second time.

Definitions

FCChan—A ‘FileCopyChannel’ object which enables efficient TCP/IP file movement between two nodes (‘spouses’).

Connection—Socket/Ipaddr-to-Socket/Ipaddr TCP connection.

While embodiments of the present invention have been described in the context of transferring a file between two servers in a private network via a dedicated link, it will be appreciated by those of ordinary skill that embodiments of the present invention would include applications in the access networks where downloading of relatively large files could be improved.

Modifications, variations and adaptations of the embodiments of the invention described above are possible within the scope of the present invention as defined in the claims.

What is claimed is:

1. A method of transferring data from a first location to a second location, comprising the steps of:
activating a link between a first location and a second location;
subdividing the link into a plurality of data transfer channels and a data transfer control channel;
at the first location, parsing a file to be transferred into a plurality of chunks, each chunk having a predetermined size;
sequencing and sending each chunk on a next available one of the plurality of data transfer channels; and
at the second location, reassembling the file by receiving and reordering chunks in dependence upon their sequence.

2. A method as claimed in claim 1 wherein the step of activating a link includes the step of establishing a dedicated link between the first location and the second location.

3. A method as claimed in claim 2 wherein the step of establishing a dedicated link establishes a high-speed TCP/IP link.

4. A method as claimed in claim 3 wherein the step of subdividing the link includes establishing a plurality of sockets between the first location and the second location.

5. A method as claimed in claim 4 wherein one of the plurality of sockets is the data transfer control channel.

6. A method as claimed in claim 5 wherein remaining sockets of the plurality of sockets are data transfer channels.

7. A method as claimed in claim 1 wherein the step of sequencing each chunk includes the step of appending a sequence indicator to each chunk.

8. A method as claimed in claim 7 wherein reordering each chunk includes the step of storing each chunk in dependence upon the sequence indicator of each chunk.

9. A method as claimed in claim 1 further comprising the step of determining a chunk has not been received.

10. A method as claimed in claim 9 wherein the step of determining a chunk has not been received includes the step of scanning the file during reassembling to identify any missing chunks and after a predetermined period, requesting retransmission of a missing chunk.

11. Apparatus for transferring data from a first location to a second location, comprising:
a link between a first location and a second location;
a module for subdividing the link into a plurality of data transfer channels and a data transfer control channel;
a file parser at the first location, for parsing a file to be transferred into a plurality of chunks, each chunk having a predetermined size;
a chunk sequencer for sequencing the chunks prior to transmission; and
a transmitter for sending each chunk on a next available one of the plurality of data transfer channels for reassembling the file at the second location, by receiving and reordering chunks in dependence upon their sequence.

12. Apparatus as claimed in claim 11 wherein the link includes a dedicated link between the first location and the second location.

13. Apparatus as claimed in claim 12 wherein the dedicated link includes a high-speed TCP/IP link.

14. Apparatus as claimed in claim 13 wherein the dedicated link is subdivided into a plurality of sockets between the first location and the second location.

15. Apparatus as claimed in claim 14 wherein one of the plurality of sockets is the data transfer control channel.

16. Apparatus as claimed in claim 15 wherein remaining sockets of the plurality of sockets are data transfer channels.

17. Apparatus as claimed in claim 11 wherein the chunk sequencer includes a device for appending a sequence indicator to each chunk.

18. Apparatus for receiving data from a first location at a second location, comprising:
a link between a first location and a second location;
a module for subdividing the link into a plurality of data transfer channels and a data transfer control channel;
a file assembler at the second location, for reassembling the file at the second location, by receiving and reordering chunks in dependence upon their sequence.

19. Apparatus as claimed in claim 18 wherein the file assembler includes a file memory for storing each chunk in dependence upon a sequence indicator of each chunk.

20. Apparatus as claimed in claim 18 further comprising a device for determining a chunk has not been received.

21. Apparatus as claimed in claim 20 wherein the device for determining a chunk has not been received includes a scanner for scanning the file memory during reassembling to identify any missing chunks and after a predetermined period, requesting retransmission of a missing chunk.
